(19) United States
(12) Patent Application Publication
(10) Pub. No.: US 2015/0251116 A1
(43) Pub. Date: Sep. 10, 2015

(54) MICRO- AND NANOFIBERS AND THEIR USE IN FORMING FIBROUS SUBSTRATES

(71) Applicant: CASE WESTERN RESERVE UNIVERSITY, Cleveland, OH (US)

(72) Inventors: Eric Baer, Cleveland, OH (US); Jia Wang, Cleveland, OH (US)

(21) Appl. No.: 14/720,020

(22) Filed: May 22, 2015

Related U.S. Application Data
(63) Continuation-in-part of application No. 14/394,234, filed on Oct. 13, 2014.
(60) Provisional application No. 62/001,942, filed on May 22, 2014.
(60) Provisional application No. 61/623,604, filed on Apr. 13, 2012.

(51) Int. Cl. B01D 39/16; B29D 99/00; B29C 47/06

(52) U.S. Cl. CPC B01D 39/1623; B29C 47/068; B29D 99/0078; B29K 2023/10

(57) ABSTRACT

A filter includes a fibrous substrate having a plurality of coextruded first polymer material fibers and second polymer material fibers. Each of the first and second fibers are separated from each other and have a rectangular cross-section defined in part by an additional encapsulating polymer material that is separated from the first polymer material fibers and second polymer material fibers.

### RELATED APPLICATIONS

This application is a Continuation-in-Part of U.S. application Ser. No. 14,394,234, filed Oct. 13, 2014, and also claims the benefit of U.S. Provisional Appln. No. 62/001,942, filed May 22, 2014, PCT Appln. No. US2013/036588, filed Apr. 15, 2013, and U.S. Provisional Appln. No. 61/623,604, filed Apr. 13, 2012, the entirety of which are incorporated herein by reference.

### GOVERNMENT FUNDING

This invention was made with government support under Grant No. 0423914 awarded by The National Science Foundation. The United States government has certain rights to the invention.

### TECHNICAL FIELD

The invention relates to polymers and, in particular, relates to coextruded, multilayered polymer films that are separated to form rectangular nanofibers and fibrous substrates.

### BACKGROUND

Polymer fibers can be used in different applications, such as membranes and reinforcing materials. Previously employed methods to produce these fibers include electrospinning of a polymer solution or melt. More specifically, the fibers can be obtained by electrospinning the polymer out of solution or the melt under high voltage. The use of this approach, however, is limited in that the proper solvents must be found and high voltage must be used, which results in high capital costs for production. Furthermore, the sizes, materials, and cross-sections of the fibers produced by electrospinning are limited. Therefore, there is a need for a process of producing polymer fibers at a reduced cost.

### SUMMARY

Embodiments described herein relate to a filter that includes a fibrous substrate having a plurality of coextruded first polymer material fibers and second polymer material fibers. Each of the first and second fibers are separated from each other and have a rectangular cross-section defined in part by an additional encapsulating polymer material that is separated from the first polymer material fibers and second polymer material fibers.

In some embodiments, the polymer materials of the film can be separated by, for example, a high pressure water or air stream or dissolving the additional encapsulating polymer material, to form a fibrous substrate that includes the plurality of the polymer material fibers having the rectangular cross-section.

In other embodiments, the fibers of the fibrous substrate can be separated from each other to form a plurality of loose fibers. The fibrous substrate can also be used to form a separation membrane and/or filter. The filter can be, for example, an air filter, a water filter, or a fuel filter. The fibers of the filter can have a high surface area-to-volume. For example, the fibers can have a surface-area-to-volume ratio greater than electrospun fibers with the same cross-sectional area.

Other embodiments described herein relate to a method of producing a fibrous substrate. The method can include coextruding at least two polymer materials to form a multilayered polymer composite stream that includes pluralities of polymer fibers formed from each polymer material. Each polymer fiber can have a rectangular cross-section and be continuous or discontinuous in the multilayered polymer composite stream. The multilayered composite stream can be coextruded with an additional encapsulating polymer material to form a multilayered polymer composite film. The polymer materials can be separated to form a fibrous substrate that includes the plurality of polymer material fibers having the rectangular cross-section.

In some embodiments, the polymer materials of the film can be separated by, for example, a high pressure water or air stream or dissolving the additional encapsulating polymer material.

In other embodiments, the fibers of the fibrous substrate can be separated from each other to form a plurality of loose fibers. The fibrous substrate can also be used as a separation membrane or filter or further processed to form the separation membrane or filter. The further processing can include mechanically orienting or shaping the fibrous substrate as well as chemically, biologically, and/or mechanically modifying the fibers and/or substrate.

Other objects and advantages and a fuller understanding of the invention will be had from the following detailed description of the preferred embodiments and the accompanying drawings.

### BRIEF DESCRIPTION OF THE DRAWINGS

FIG. 1 is a schematic illustration of a coextrusion and layer multiplying process used to form a multilayered polymer composite film in accordance with one embodiment.

FIGS. 2A-E are schematic illustrations of a coextrusion and layer multiplying process of FIG. 1.

FIGS. 3A-C are schematic illustrations of stretching, compressing, and delaminating of the composite film of FIG. 2.

FIG. 4 is schematic illustration of a delaminating device for separating the polymer fibers in accordance with an embodiment.

FIG. 5 is a flow chart illustrating a method of forming rectangular polymer fibers in accordance with the present invention.

FIG. 6 is a schematic illustration of an example of a methodology of forming a fuel filter produced from extruded and oriented PP/PA6 polymer fibrous substrates containing polystyrene as an encapsulation or skin layer.

FIG. 7 illustrates SEM images of nanofibers of a fuel filter produced from extruded PP/PA6 polymer fibrous substrates containing polystyrene as an encapsulation or skin layer.

FIG. 8 illustrates SEM images of oriented nanofibers of a fuel filter produced from extruded and oriented PP/PA6 polymer fibrous substrates containing polystyrene as an encapsulation or skin layer.

FIG. 9 graphically compares the mechanical properties of fuel filters formed from nanofibers of PP/PA6 polymer blends containing a polystyrene skin layer before and after orientation and a commercially available fuel filter.

FIG. 10 illustrates tables summarizing the mechanical properties and the surface area of fuel filters formed from nanofibers PP/PA6 polymer blends containing a polystyrene skin layer before and after orientation and a commercially available fuel filter.

FIG. 11 is a schematic illustration of an example of a methodology of forming a fuel filter produced from extruded and oriented PP/PA6 polymer fibrous substrates containing a 50/50 blend of PPA and PA6 as an encapsulation or skin layer.

FIG. 12 illustrates images of nanofibers of a fuel filter produced from extruded PP/PA6 polymer fibrous substrates containing PPA/PA6 as an encapsulation or skin layer prepared by the methodology shown in FIG. 11.

FIG. 13 illustrates tables summarizing the surface area of fuel filters formed from nanofibers of PP/PA6 polymer blends containing a PP/PA6 skin layer and a commercially available fuel filter.

### DETAILED DESCRIPTION

Embodiments described herein relate to polymers and, in particular, relate to coextruded, multilayered polymer films that can be delaminated to form rectangular nano-fibers, fibrous substrates, separation membranes, and/or filters. The multilayered polymer films can be formed using solvent-free coextrusion and multiplying processes and provide fibers with higher surface area-to-volume than electrospun fibers with the same cross-sectional area as well as separation membranes and filters with enhanced surface area and mechanical properties compared commercially available separation membranes and filters.

In some embodiments, a multilayered polymer composite film includes at least two polymer materials coextruded with one another to form a multilayered polymer composite stream. The multilayered polymer composite stream includes a plurality of polymer fibers formed from each polymer material. Each polymer fiber can have a rectangular cross-section. The film also includes an additional encapsulating polymer material coextruded with the multilayered polymer composite stream.

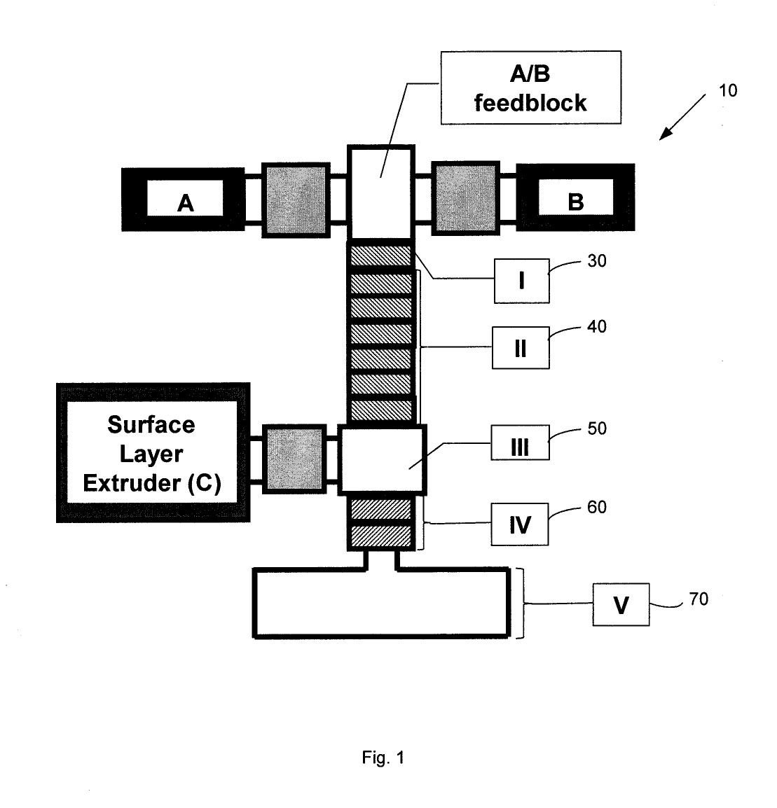

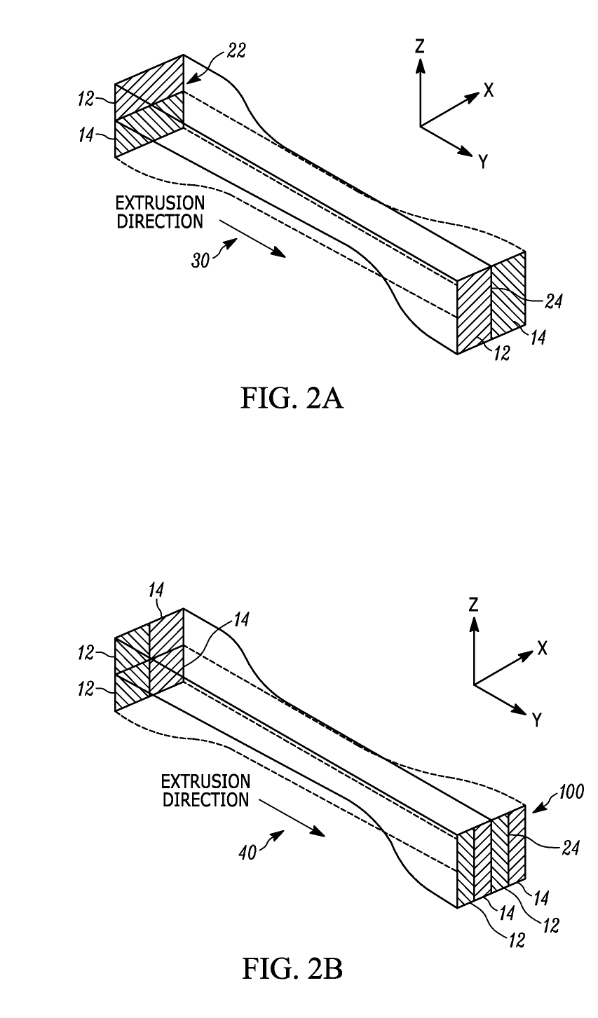

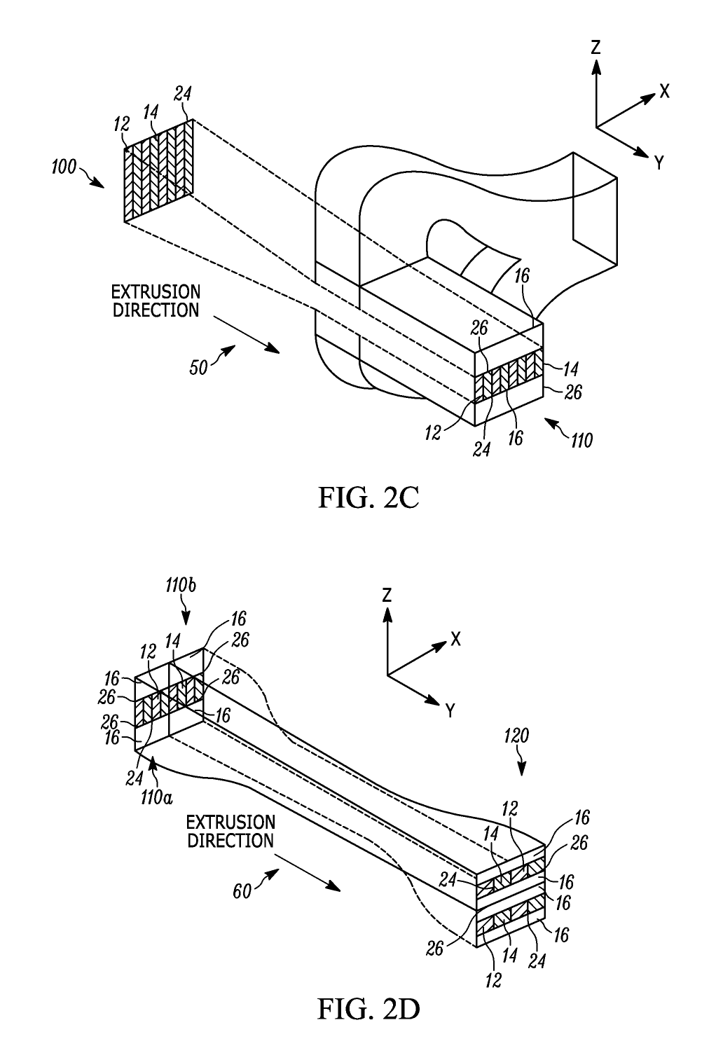

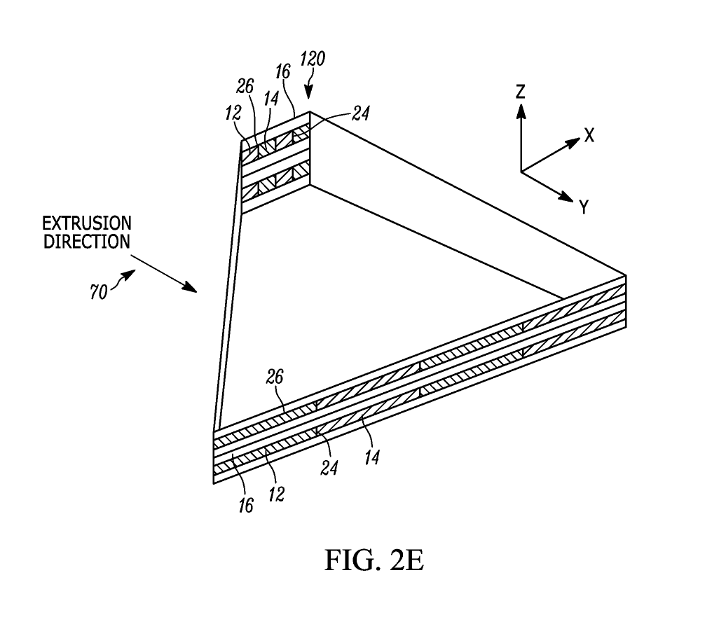

FIGS. 1 and 2A-2E illustrate a coextrusion and multiplying or multilayering process 10 used to form a multilayered polymer composite film 120 in accordance with one embodiment. In the process 10, a first polymer layer 12 and a second polymer layer 14 are provided. The first layer 12 is formed from a first polymer material (A) and the second polymer layer 14 is formed from a second polymer material (B) that has a substantially similar viscosity and is substantially immiscible with the first polymer material (A) when coextruded. The first and second polymer materials (A), (B) are coextruded to form a polymer composite having a plurality of discrete layers 12, 14 that collectively define a multilayered polymer composite stream 100. It will be appreciated that one or more additional layers formed from the polymer materials (A) or (B) or formed from different polymer materials may be provided to produce a multilayered polymer composite stream 100 that has at least three, four, five, six, or more layers of different polymer materials. An additional encapsulating layer or third polymer layer 16 formed from a third polymer material (C) is then coextruded with the polymer stream 100 to form a multilayered polymer composite stream 110 that is multiplied to form the multilayered polymer composite film 120. The third polymer material (C) can be substantially immiscible with the first and second polymer materials (A), (B) so that the third polymer layer can be potentially separated from the first and second polymer materials (A), (B).

Polymer materials used in the process described herein can include a material having a weight average molecular weight (MW) of at least 5,000. Preferably, the polymer is an organic polymeric material. Such polymer materials can be glassy, crystalline or elastomeric polymer materials.

Examples of polymer materials that can potentially be coextruded to form the fibers and/or encapsulation polymer material, e.g., the first, second, and third polymer materials (A), (B), (C), include, but are not limited to, polyesters, such as poly(ethylene terephthalate) (PET), poly(butylene terephthalate), polycaprolactone (PCL), and poly(ethylene naphthalate)polyethylene; naphthalate and isomers thereof, such as 2,6-, 1,4-, 1,5-, 2,7-, and 2,3-polyethylene naphthalate; polyalkylene terephthalates, such as polyethylene terephthalate, polybutylene terephthalate, and poly-1,4-cyclohexanedimethylene terephthalate; polyimides, such as polyacrylic imides; polyetherimides; styrenic polymers, such as polystyrene (PS), atactic, isotactic and syndiotactic polystyrene, a-methyl-polystyrene, para-methyl-polystyrene; polycarbonates, such as bisphenol-A-polycarbonate (PC); polyethylenes oxides; poly(meth)acrylates such as poly(isobutyl methacrylate), poly(propyl methacrylate), poly(ethyl methacrylate), poly(methyl methacrylate), poly(butyl acrylate) and poly(methyl acrylate) (the term “(meth)acrylate” is used herein to denote acrylate or methacrylate); cellulose derivatives; such as ethyl cellulose, cellulose acetate, cellulose propionate, cellulose acetate butyrate, and cellulose nitrate; polyalkylene polymers such as polypropylene, polyethylene, high density polyethyelene (HDPE), low density polyethylene (LDPE), polybutylene, polyisobutylene, and poly(4-methyl)pentene; fluorinated polymers such as perfluoroalkoxy resins, polytetrafluoroethylene, fluorinated ethylene-propylene copolymers, polyvinylidene fluoride, polyvinylidene difluoride (PVDF), and polychlorotrifluoroethylene and copolymers thereof; chlorinated polymers such as polydichlorostyrene, polyvinylidene chloride and polyvinylchloride; polysulfones; polyethersulfones; polyacrylonitrile; polyamides such as nylon, nylon 6,6, polycaprolactam, and polyamide 6 (PA6); polyvinylacetate; polyether-amides.

Copolymers, such as styrene-acrylonitrile copolymer (SAN), preferably containing between 10 and 50 wt %, preferably between 20 and 40 wt %, acrylonitrile, styrene-ethylene copolymer; and poly(ethylene-1,4-cyclohex-ylenedimethylene terephthalate) (PETG), can also be used as the polymer material. Additional polymer materials include an acrylic rubber; isoprene (IR); isobutylene-isoprene (IIR); butadiene rubber (BR); butadiene-styrene-vinyl pyridine (PSBR); butyl rubber; chloroprene (CR); epichlorohydrin rubber; ethylene-propylene (EPM); ethylene-propylene-diene (EPDM); nitrile-butadiene (NBR); polyisoprene; silicon rubber; styrene-butadiene (SBR); and urethane rubber. Polymer materials can also include include block or graft copolymers. In one instance, the polymer materials used to form the layers 12, 14, 16 may constitute substantially immiscible thermoplastics that when coextruded have a substantially similar viscosity.

In addition, each individual layer 12, 14, 16 may include blends of two or more of the above-described polymers or copolymers. The components of the blend can be substantially miscible with one another yet still maintaining substantial immiscibility between the layers 12, 14, 16. Preferred polymeric materials include polypropylene combined with polyethylene and polystyrene, polypropylene combined with HDPE and polystyrene, polypropylene combined with LDPE, polypropylene combined with PVDF and polystyrene, and copolymers thereof. In another example, the first polymer material (A) constitutes polyethylene and the second polymer material (B) constitutes PVDF or Nylon. In another example, the first polymer material (A) constitutes a blend of polypropylene and LDPE, the second polymer material (B) constitutes a blend of polypropylene and HDPE, and the third polymer material (C) constitutes polystyrene. In another example, the first polymer material (A) constitutes polypropylene, the second polymer material (B) constitutes polyamide 6, and the third polymer material (C) constitutes polystyrene. In another example, the first polymer material (A) constitutes polypropylene, the second polymer material (B) constitutes polyamide 6, and the third polymer material (C) constitutes a blend of polypropylene and polyamide 6. In another example, the first polymer material (A) constitutes polypropylene, the second polymer material (B) constitutes PVDF, and the third polymer material (C) constitutes polystyrene.

In some embodiments, the polymer materials comprising the layers 12, 14, 16 can include organic or inorganic materials, including nanoparticulate materials, designed, for example, to modify the mechanical properties of the polymer materials, e.g., tensile strength, toughness, and yield strength. It will be appreciated that potentially any extrudable polymer material can be used as the first polymer material (A), the second polymer material (B), and the third polymer material (C) so long as upon coextrusion such polymer materials (A), (B), (C) are substantially immiscible, have a substantially similar viscosity, and form discrete layers or polymer regions.

Referring again to FIGS. 1 and 2A-2E, the layers 12, 14, 16 are co-extruded and multiplied in order to form the multilayered polymer composite film 120. In particular, a pair of dies 30, 40 (see FIGS. 2A and 2B) is used to coextrude and multiply the layers 12, 14. Each layer 12, 14 initially extends in the y-direction of an x-y-z coordinate system. The y-direction defines the length of the layers 12, 14 and extends in the general direction of flow of material through the dies 30, 40. The x-direction extends transverse, e.g., perpendicular, to the y-direction and defines the width of the layers 12, 14. The z-direction extends transverse, e.g., perpendicular, to both the x-direction and the y-direction and defines the height or thickness of the layers 12, 14.

Referring to FIG. 2A, the layers 12, 14 are initially stacked in the z-direction and define an interface (not shown) there between that resides in the x-y plane. As the layers 12, 14 approach the first die 30 they are separated from one another along the z-axis to define a space 22 there between. The layers 12, 14 are then re-oriented as they pass through the first die 30. More specifically, the first die 30 varies the aspect ratio of each layer 12, 14 such that the layers 12, 14 extend longitudinally in the z-direction. The layers 12, 14 are also brought closer to one another until they engage or abut one another along an interface 24 that resides in the y-z plane. Alternatively, the layers 12, 14 are coextruded as they pass through the die 16 such that the interface 24 includes chemical bonds (not shown).

Referring to FIG. 2B, the layers 12, 14 then enter the second die 40 where layer multiplication occurs. The second die 40 may constitute a single die or several dies which process the layers 12, 14 in succession (not shown). Each layer 12, 14 is multiplied in the second die 40 to produce a plurality of first layers 12 and a plurality of second layers 14 that alternate with one another to form a first multilayered polymer composite stream 100. Each pair of adjoining layers 12, 14 includes the interface 24 that resides in the y-z plane. The layers 12, 14 are connected to one another generally along the x-axis to form a series of discrete, alternating layers 12, 14 of polymer material (A), (B). Although four of each layer 12 and 14 are illustrated it will be appreciated that the first composite stream 100 may include, for example, up to thousands of each layer 12, 14.

Once the first composite stream 100 is formed a detachable encapsulation or separation layer 16 is applied to the top and bottom of the first composite stream 100. In particular, the first composite stream 100 enters a third die 50 (see FIG. 2C) where the first composite stream is sandwiched between two separation layers 16 along the z-axis to form a second multilayered polymer composite stream 110. Upon coextrusion, the first composite stream 100 and the separation layers 16 engage or abut one another along interfaces 26 that reside in the x-y plane. The separation layer 16 is formed from a third polymer material (C) different from the first and second polymer materials (A), (B). One or both of the separation layers 16 may, however, be omitted (not shown).

As shown in FIG. 2D, the second composite stream 110 may be divided along the x-axis into a plurality of branch streams 110a, 110b and processed through a multiplying die 60. In the die 60, the streams 110a, 110b are stacked in the z-direction, stretched in both the x-direction and the y-direction, and recombined to form the multilayered polymer composite film 120 that includes a plurality of multilayered streams 100 alternating with separation layers 16. Each pair of adjoining first composite streams 100 and separation layers 16 includes the interface 26 that resides in the x-y plane. The interfaces 24 are also maintained between the layers 12, 14 in the multilayered polymer composite film 120.

The composite film 120 can be extruded through a die 70 (see FIG. 2E) that allows biaxially stretching of the composite film. Biaxial stretching of the composite film 120 in the x-direction and y-direction within the die 70 may be symmetric or asymmetric.

The multilayered polymer composite film 120 shown in FIGS. 2D and 2E includes two first composite streams 100 that alternate with three separation layers 16, although more or fewer of the first composite streams 100 and/or of the layers 16 may be present in the multilayered polymer composite film 120. Regardless, the multilayered polymer composite film 120 includes a plurality of layer interfaces 24 between the layers 12, 14 and a plurality of layer interfaces 26 between the first composite streams 100 and separation layers 16.

By changing the volumetric flow rate of the polymer layers 12, 14 through the dies 30, 40 the thickness of the polymer layers 12, 14 and the first multilayered composite stream 100 in the z-direction can be precisely controlled. Additionally, by using detachable separation layers 16 and multiplying the second composite stream 110 within the die 60, the number and dimensions of the layers 12, 14, 16 and branch streams 110a, 110b in the x, y, and z-directions can be controlled. Consequently, the composition of the multilayered polymer composite film 120 can be precisely controlled.

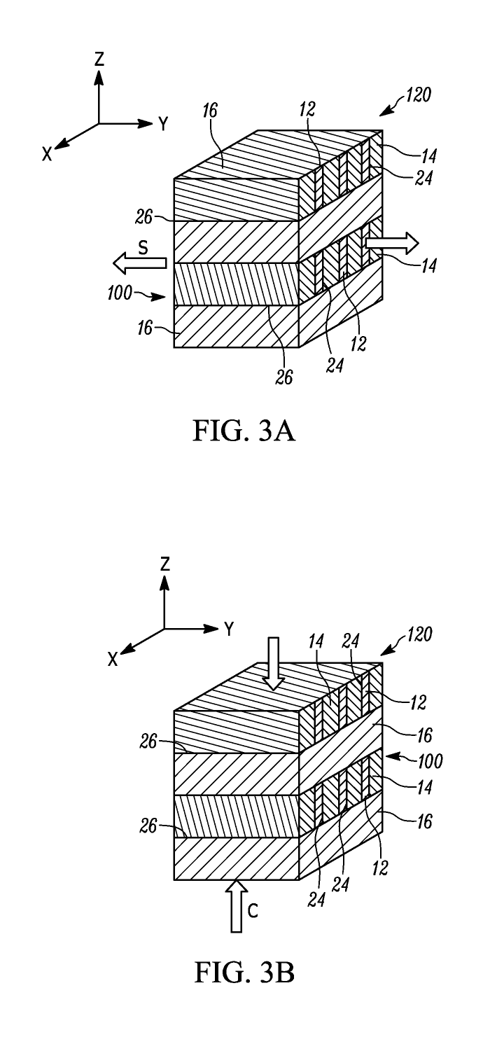

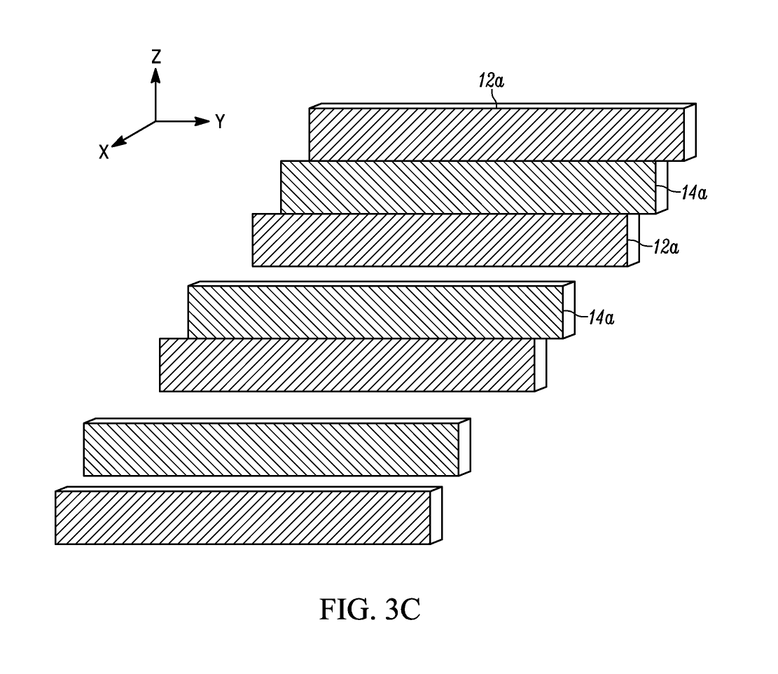

Referring to FIGS. 3A, and 3B, the multilayered polymer composite film 120 may be mechanically processed by, for example, at least one of stretching (FIG. 3A), compression (FIG. 3B), and ball-mill grinding (not shown) during or after coextrusion. As shown, the multilayered polymer composite film 120 is stretched in the y-direction as indicated generally by the arrow “S”, although the multilayered polymer composite film 120 may alternatively be stretched in the x-direction (not shown). FIG. 3B illustrates the multilayered polymer composite film 120 being compressed in the z-direction as indicated generally by the arrow “C”. The degree of stretching and/or compression will depend on the application in which the multilayered polymer composite film 120 is to be used. The ratio of y-directional stretching to z-direction compression may be inversely proportional or disproportional.

Referring to FIG. 3C, the multilayered polymer composite film 120 can be further processed to cause the components 12, 14, 16 thereof to separate or delaminate from one another and form a plurality of fibers, fiber-like structures, or fibrous substrate from the layers 12, 14, and/or 16. In some embodiment the separation layers can be maintained in the fibrous substrate. In other embodiments, the separation layers 16 can be removed and discarded.

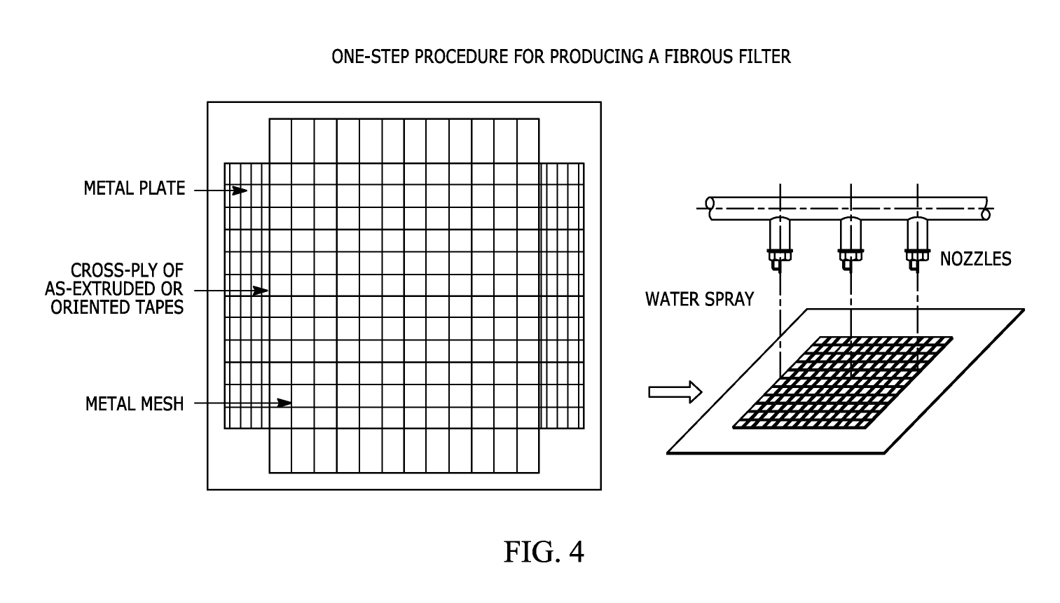

In one instance, as shown schematically in FIG. 4, the layers 12, 14, 16 are mechanically separated by high pressure water jets. In particular, the multilayered polymer composite film 120 can be fixed between a metal plate and a metal mesh, and pressurized water jets can supply high pressure water to the composite film to separate the layers 12, 14, 16, thereby forming the nanofibers 12a, 14a (FIG. 3C). More specifically, applying high pressure water to the multilayered polymer composite film 120 removes the interfaces 24 between the layers 12, 14, i.e., delaminates the first composite stream 100, and removes the interfaces 26 between the composite streams 100 and layers 16, delaminating the second composite stream 110 to form the fibers 12a and 14a. Although delamination of the multilayered polymer composite film 120 is illustrated, it will be appreciated that the first or second composite streams 100, 110 or the branch streams 110a, 110b may likewise be delaminated via high pressure water or the like to form the fibers 12a, 14a. In any case, the specifics of the pressurized water jet delamination process can be tailored depending on the nature of the multilayered polymer composite film 120. For example, the water may be supplied at a particular pressure, e.g., from about 200 psi to about 1600 psi, for a particular duration, e.g., from about 1 minutes to about 20 minutes, and at a particular temperature, e.g., from about 80° C. to about 105° C.

Alternatively, the polymer materials (A) or (B) of the layers 12, 14 are selected to be insoluble in a particular solvent while the polymer material (C) of the separation or encapsulation layer 16 is selected to be soluble in the solvent. Accordingly, immersing the composite film 120 in the solvent separates the layers 12, 14 by wholly or partially removing, e.g., dissolving, not only the interfaces 24, 26 between the layers 12, 14, 16 but the soluble layers 16 entirely. The insoluble layers 12, 14 are therefore left behind following solvent immersion and form the fibers 12a or 14a. The solvent may constitute, for example, water, an organic solid or an inorganic solvent.

Whether the fibers 12a, 14a are formed by mechanically separating the layers 12, 14, 16 or dissolving one of the layers 16 with a solvent, the nanofibers 12a, 14a produced by the described coextrusion process have rectangular cross-sections rather than the conventional, round cross-sections formed by electrospinning. These rectangular and/or ribbon-like nanofibers 12a, 14a have a larger surface area-to-volume ratio than round fibers developed using spinning methods and can be provided as fibrous substrates that can be used as separation membranes and filters. Regardless of the method of separation employed, the nanofibers 12a, 14a can stretch, oscillate, and separate from each other at the interfaces 24, 26. Furthermore, due to the aforementioned mechanical processing techniques of FIGS. 3A and 3B, the exact cross-sectional dimensions of the rectangular fibers 12a, 14a can be precisely controlled. For example, the rectangular fibers 12a, 14a can be made smaller and strengthened via mechanical processing.

Although multiple separation techniques are described for forming the rectangular fibers 12a, 14a, one having ordinary skill in the art will understand that the multilayered polymer composite film 120 or the composite streams 100, 110 or branch streams 110a, 110b may alternatively be left intact. In this instance, and referring back to FIGS. 1 and 2A-2E, the rectangular polymer fibers may constitute the layers 12, 14 coextruded with the surrounding layers 16. The layers 12, 14 exhibit substantially the same properties as the separated fibers 12a, 14a. In any case, the fibers 12, 12a, 14, 14a may be on the microscale or nanoscale in accordance with the present invention.

Due to the construction of the multilayered polymer composite film 120 and the fixed sizes of the dies 30-70, the compositions of the vertical layers 12, 14 and separation layers 16 are proportional to the ratio of the height in the z-direction of a vertical layer 12, 14 section to that of a separation layer 16 section. Therefore, if the layer 12 (or 14) is selected to form the rectangular fibers 12a (or 14a), the thickness and height of the final fibers 12a (or 14a) can be adjusted by changing the ratio of the amount of the layers 12, 14 as well as the amount of separation layer 16. For example, increasing the percentage of the amount of the material (B) of the layers 14 relative to the amount of the material (A) of the layers 12 and/or increasing the amount of the material (C) of the separation layers 16 results in smaller rectangular fibers 12a. Alternatively, one or more of the dies 30-60 may be altered to produce nanofibers 12, 12a, 14, 14a having a size and rectangular cross-section commensurate with the desired application. In one instance, one or more of the dies 30-60 could be modified to have a slit or square die construction to embed the fibers 12, 12a, 14, 14a within individual separation layers 16.

The method described herein is advantageous in that it can produce polymer nanofibers 12, 12a, 14, 14a made of more than one material, which was previously unattainable using single-shot extrusion. The method also allows for the use of any polymers that can be melt-processed to produce fibers 12, 12a, 14, 14a, in contrast to conventional electrospinning processes that are more confined in material selection. Also, the method of the present invention does not involve using costly organic solvents or high voltage compared to electrospinning.

The multilayered polymer composite film 120 can be tailored to produce vertically layered films 120 with designer layer/fiber thickness distributions. For example, the relative material compositions of the polymers (A), (B), (C) of the layers 12, 14, 16 can be varied with great flexibility to produce rectangular polymer fibers 12, 12a, 14, 14a with highly variable constructions, e.g., 50/50, 30/70, 70/30, etc. The rectangular polymer fibers 12, 12a, 14, 14a of can be highly oriented and strengthened by post-extrusion orienting. Furthermore, a wide magnitude of layer 12, 14 thicknesses in the z-direction is achievable from a few microns down to tens of nanometers depending on the particular application.

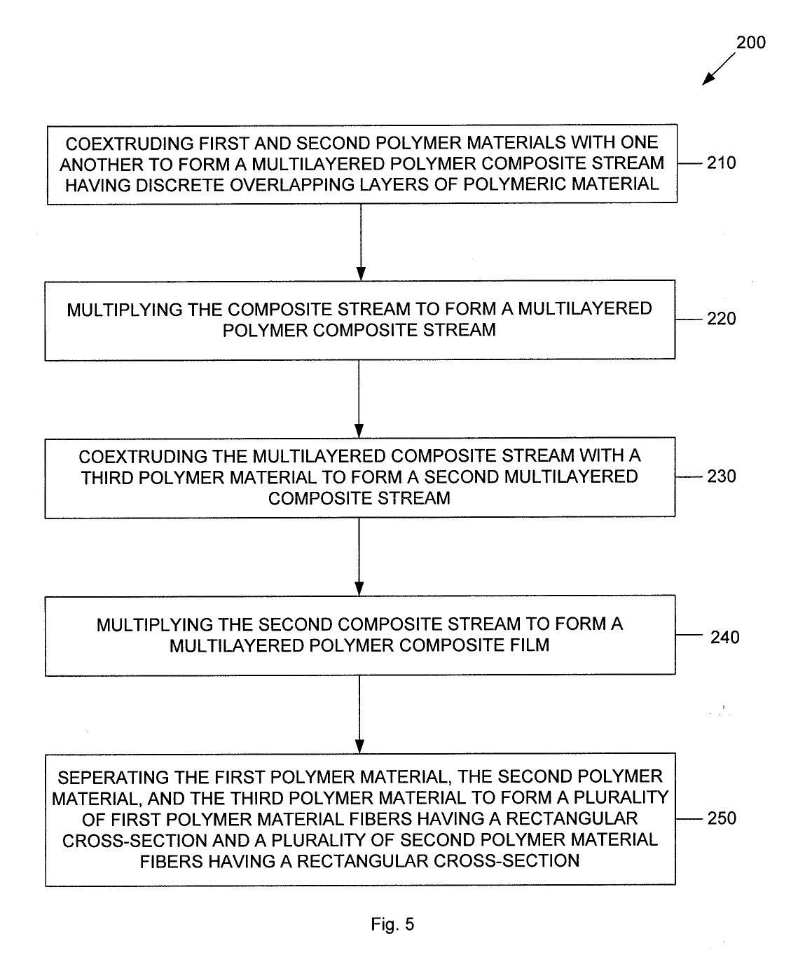

Moreover, the process described herein allows for the production of extremely high-aspect ratio fibers 12, 12a, 14, 14a that can form a fibrous substrate. FIG. 5 is a flow chart illustrating a method 200 of producing a fibrous substrate that includes nanoscale fibers described herein. In step 210, a first polymer material is coextruded with a second polymer material to form a coextruded polymer composite stream having discrete overlapping layers of polymeric material. In step 220, the overlapping layers are multiplied to form a first multilayered composite stream. In step 230, the first composite stream is coextruded with a third polymer material to form a second multilayered composite stream. In step 240, the second composite stream is multiplied to form a multilayered polymer composite film. In step 250, the first and second polymer materials are separated from one another and from the third polymer material to form a fibrous substrate that includes a plurality of first polymer material fibers having a rectangular cross-section and a plurality of second polymer material fibers having a rectangular cross-section.

The fibrous substrate formed from the multilayered polymer composite film 120 that includes a plurality of rectangular fibers 12, 12a, 14, 14a can be used in a number of applications. For example, the fibrous substrate can be used to form polymer nanofiber separation membranes. A separation membrane formed from the nanofibers 12a, 14a can act as a permeable membrane for diffusion of fluids, such as gaseous or liquid fluids, as well as ions therebetween.

The separation membrane formed from the fibrous substrate can have, for example, enhanced chemical stability, a thickness of 1 μm to greater than 10 cm, a porosity of 1% to 99% by volume, a pore size of less than 1 μm to greater than 1 mm, and a permeability, mechanical strength, puncture strength, tensile strength, wettability, and thermal capabilities that can be readily tailored for specific applications. In some embodiments, the nanofiber separation membrane can advantageously have enhanced mechanical properties and reduced pore size and thicknesses compared to conventional nonwoven separators. The thickness and pore structure controls the mechanical properties of the separator.

The fibrous substrate formed from the multilayered polymer composite film 120 can also be used to form membrane supports and/or membranes with the fibers 12, 12a, 14, 14a. For example, highly porous membrane supports as well as membranes can be produced by partially adhering the fibers 12a, 14a of the fibrous substrate to one another using various techniques following delamination or separation. The membranes or membrane mats formed in this manner are useful in different processes, such as filtration (of water, fuel, and/or air), desalination, and water purification. In one example, the fibers of the present invention are useful in forming water filtration membranes for performing microfiltration, i.e., size exclusion on the order of 10² nm-10⁴ nm commensurate with bacteria and pigments. Microfiltration typically utilizes filters with a pore size of about 0.1-10 μm and is useful in desalination, wastewater treatment, separation of oil/water emulsions, and cold sterilization in the food and pharmaceutical industries. Parameters associated with and important for water filtration include, but are not limited to: pore size and distribution, surface area, fiber dimension, filter thickness, pure water flux, rejection of solute, hydrophobicity, and mechanical properties.

Filtration mechanisms for air particles are dependent upon the porosity and surface area of the fibers, thereby affecting the straining, inertial impaction, interception, and diffusion of air particles therethrough. Consequently, the fibers 12a, 14b of the present invention, which can be precisely tailored to have a desired porosity and/or surface area, are advantageous for use filtration applications. In particular, the porosity of the membrane supports for filters can be controlled by altering the fiber 12a, 14a dimensions and/or altering the layers 12, 14 of the composite film 120. Furthermore, by orientating the fibers 12a, 14b the filtration membranes produced by the present invention are significantly stronger than convention nanofiber filters and less prone to breakage and agglomeration.

In some embodiments, the fibers of the filter or membrane can be physically, chemically, and or biologically modified to modify the mechanical, chemical, electrical, and/or biological properties of the fibers, filter, and/or membrane. For instance, substances can be deposited within, anchored to, and/or placed on the fibers or the membrane to modify the hydrophobicity or hydrophilicity of the fibers, the ion diffusion properties of a membrane formed from the fibers, and the strength and durability of the fibers. In some embodiments, the fibers, membrane, and/or filter can be treated with catalyst that react with or facilitates reaction of fluid that is contact with or diffuses, permeates, or passes through the membrane or filter. In other embodiments, a bioactive agent can be deposited on or conjugated to the fibers, and the fibers can be used as a substrate to deliver the bioactive agent to cells, tissue, and/or a subject in need thereof.

### Example 1

A fiber-based air filter was formed by coextruding and multiplying PP(2252)/LDPE(MFI=2) blends and PP(1572)/HDPE(ρ=0.96) blends with compositions of 70/30, 50/50, and 30/70 (PP/PE). 9% PS separation layers were coextruded with the blends. The 2-component blend with separation layer formed 512/64 multilayered polymer composite films. The three components were delaminated from one another using a water jet, thereby forming a plurality of rectangular PP fibers and a plurality of rectangular PE fibers. The PS was discarded.

As extruded, the 70/30 PP/LDPE nanofibers had a surface area of about 0.226 m²/g and, when oriented, had a surface area of about 1.94 m²/g. It is clear that orientation of the nanofibers improved the surface area by a factor of 8.6. For comparison, Donaldson UltraWeb air filters have a surface area of 0.167 m²/g and Donaldson Cellulose air filters have a surface area of 0.215 m²/g. Consequently, the nanofibers of the present invention had a surface area 11.6 times higher than current nanofiber filter technology and 9 times higher than standard filters. The nanofibers of the present invention advantageously increased the efficiency of the air filter by reducing the pore size, increasing the surface area for particle collection, reducing the pressure drop, and by being sized similar to the particles to be filtered, thereby increasing adhesion therebetween.

### Example 2

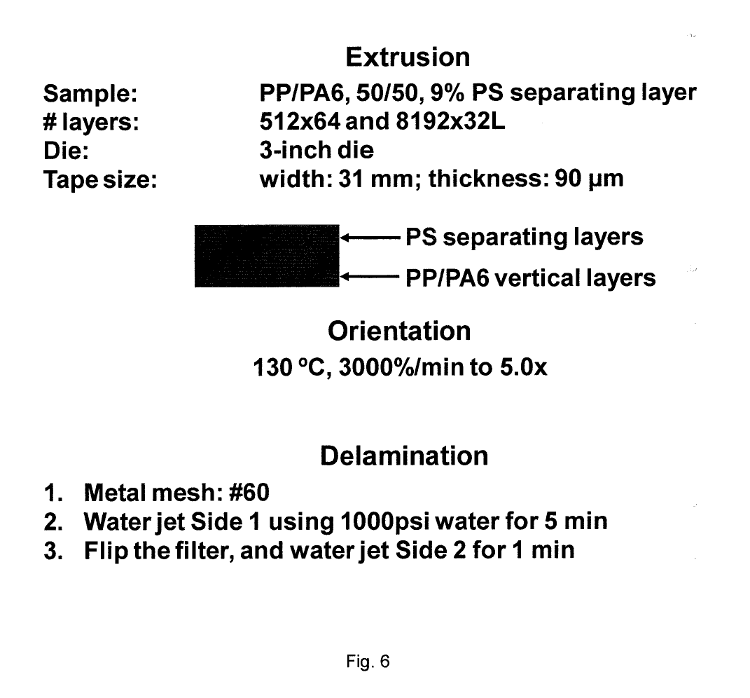

In this example, fuel filters were formed by coextruding and multiplying polypropylene (PP) and polyamide 6 (PA6) with a 9% separation layer of polystyrene (PS). As illustrated schematically in FIG. 6, PP (Exxon Mobil 2252E4) and polyamide 6 (BASF Ultramid B36 01) were co-extruded and multiplied to form a 8192 by 32 alternating-layered matrix structure with a 50/50 composition. PS (Styron 685) was used as the separating layer material, and the composition was 9%. The melt flow was extruded from a 3″-wide die, and formed a tape on a chill roll at 60° C. rolling at 15 rpm. The width and thickness of the tape was 31 mm and 0.09 mm, respectively.

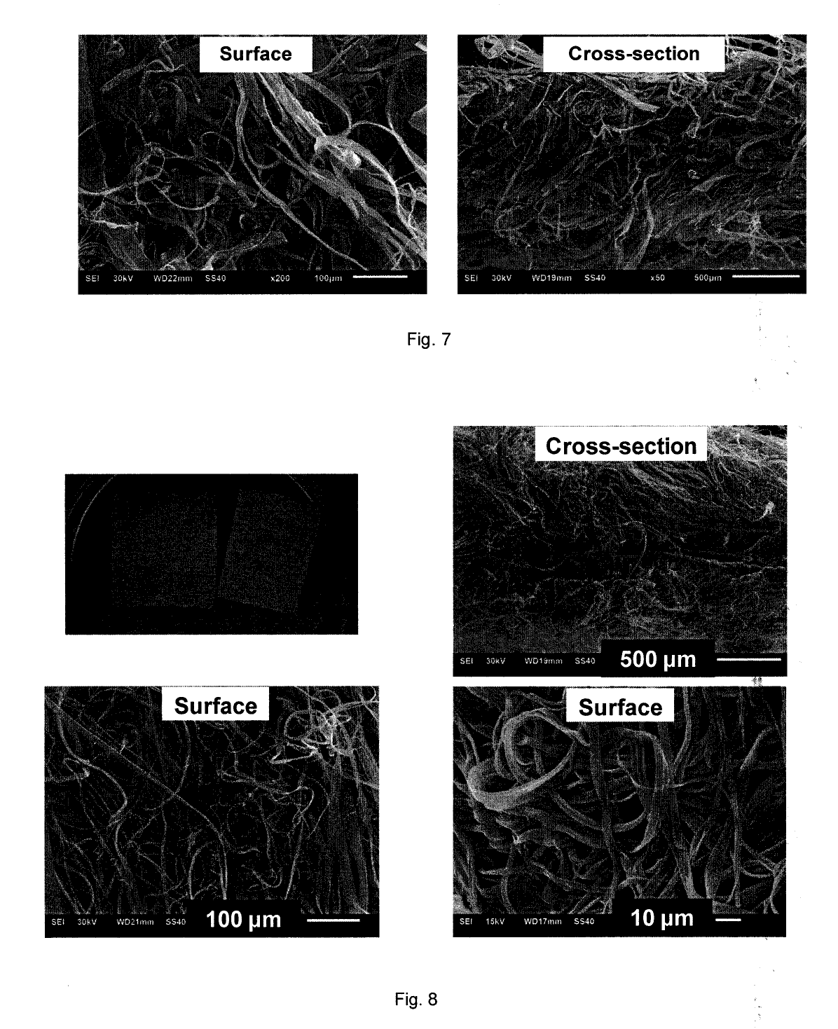

Tapes formed using the multilayer co-extrusion process were then delaminated using a delamination process. In the delamination process, a set of four fiber tapes (width=12 mm, thickness=0.25 mm) placed parallel to one another on a metal plate. A #60 metal mesh was placed over the tapes to secure the tapes to the mesh. A 1000 psi water jet was applied to the top side of the tapes in the longitudinal direction for 5 minutes. The tapes were flipped over and the same water jet applied to the bottom side for 1 minutes to delaminate the rectangular PP and PA6 fibers from the PS and from one another. As shown in FIG. 7, delaminating was uniform throughout the thickness of the filter. By using the metal mesh, the PP and PA6 fibers were distributed uniformly and the thickness of the fibers was largely decreased. The rectangular nanofibers of the filter had a width of about 1 μm to about 25 μm (e.g., about 12.9 μm) and a thickness of about 0.5 μm to about 2.5 μm (e.g., about 1.5 μm).

Alternatively, the tapes formed using the multilayer coextrusion process were oriented prior to delamination. The tapes were oriented at 130° C. at a rate of 3000%/min to 5.0x their length. The axial oriented tapes were then delaminated as described above. The oriented, delaminated, rectangular fibers had a thickness of about 1 μm to about 10 μm (e.g., about 6 μm) and a width of about 0.3 to about 1 μm. The filter had an estimated pore size of 1 about 10 μm and a thickness of 0.45 mm.

FIGS. 7 and 8 illustrate SEM images of nanofibers of unoriented and oriented fuel filters produced from extruded PP/PA6 polymer fibrous substrates containing polystyrene as an encapsulation or skin layer. Both the surface and the cross-sectional sample were prepared for each filter. The cross-sectional samples were made by cutting the filter using a razor blade. The samples were coated with gold, and were observed using a JEOL SEM instrument at various magnifications.

The mechanical properties and Brunauer-Emmett-Teller (BET) Theory surface area of commercially available fuel filters and filters made from as-extruded PP/PA6 fibers and filters made from oriented PP/PA6 fibers were tested and compared.

For the mechanical tests, the filter samples were cut into a 10 mm wide rectangular shape. The two ends of each sample was held in the grips, and the gauge length was 20 mm. The thicknesses were measured for each sample using a micrometer. The mechanical tests were conduct using an MTS (Mechanical Testing System) instrument with a 1 kN load cell. The tests were performed at room temperature at a 100%/min strain rate until the sample breaks. The tensile strength was measured by taking the maximum stress in the stress-strain curve for each sample, and the modulus was the tangent modulus at 2% strain. The total energy for each sample indicates its toughness, and was quantifies by measuring the area under the stress-strain curve for each sample. Three measurements were done for each sample, and the average values were used in the summary.

For the surface area data, the filter samples were dried and degassed at 70° C. for two hours under a nitrogen gas atmosphere. The surface area for each filter was measured using a Micromeritics Tristar II BET instrument.

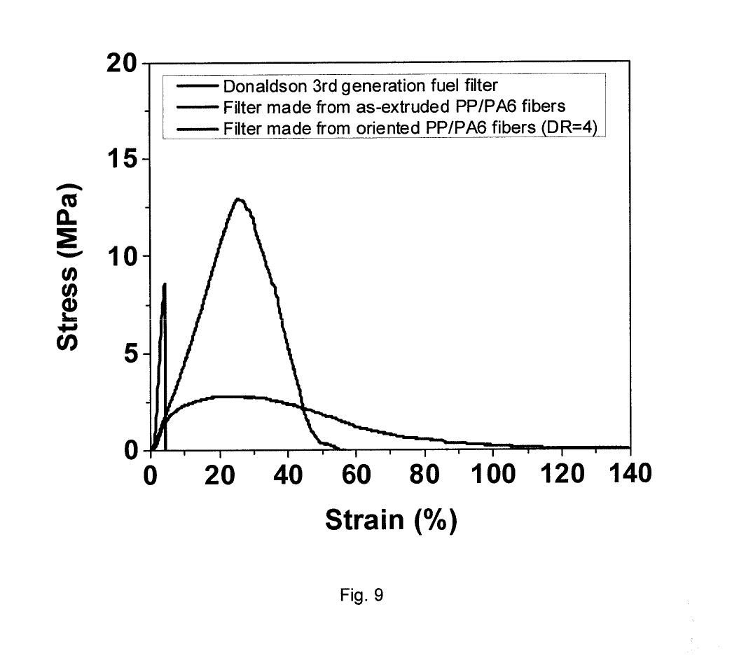

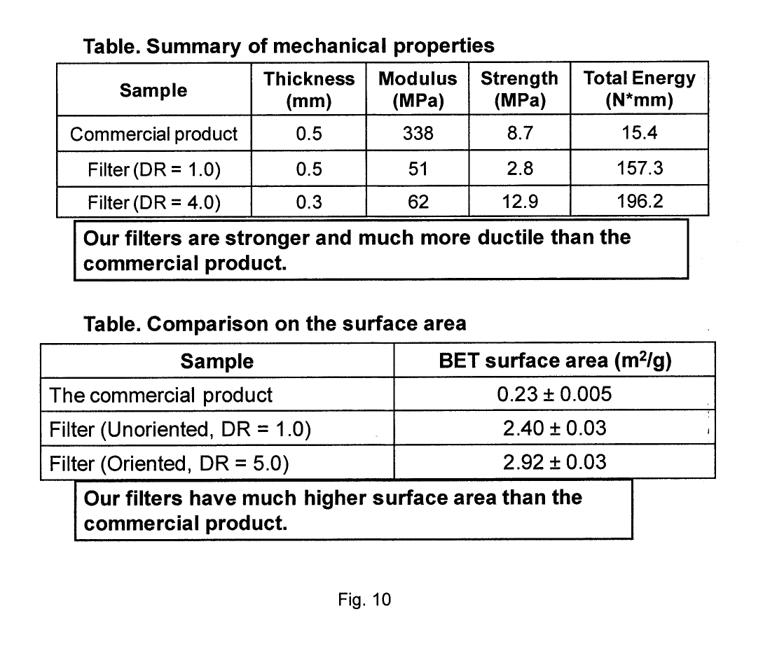

FIGS. 9 and 10 show that filters made from as-extruded PP/PA6 fibers and filters made from oriented PP/PA6 fibers were stronger and more ductile than commercially available fuel filters. Filters made from as-extruded PP/PA6 fibers and filters made from oriented PP/PA6 fibers also have a higher surface area than the commercially available fuel filters.

### Example 3

In this example, fuel filters were formed by coextruding and multiplying polypropylene (PP) and polyamide 6 (PA6) with a 9% separation layer of a 50/50 blend of polypropylene and polyamide 6. As illustrated schematically in FIG. 11, PP (Exxon Mobil 2252E4) and polyamide 6 (BASF Ultramid B36 01) were co-extruded and multiplied to form a 1024 by 32 alternating-layered matrix structure with a 50/50 composition. A PP/PA6 50/50 blend was used as the separating layer material, and the composition was 9%. The melt flow was extruded from a 3″-wide die, and formed a tape on a chill roll at 60° C. rolling at 15 rpm. The width and thickness of the tape was 52 mm and 0.19 mm, respectively.

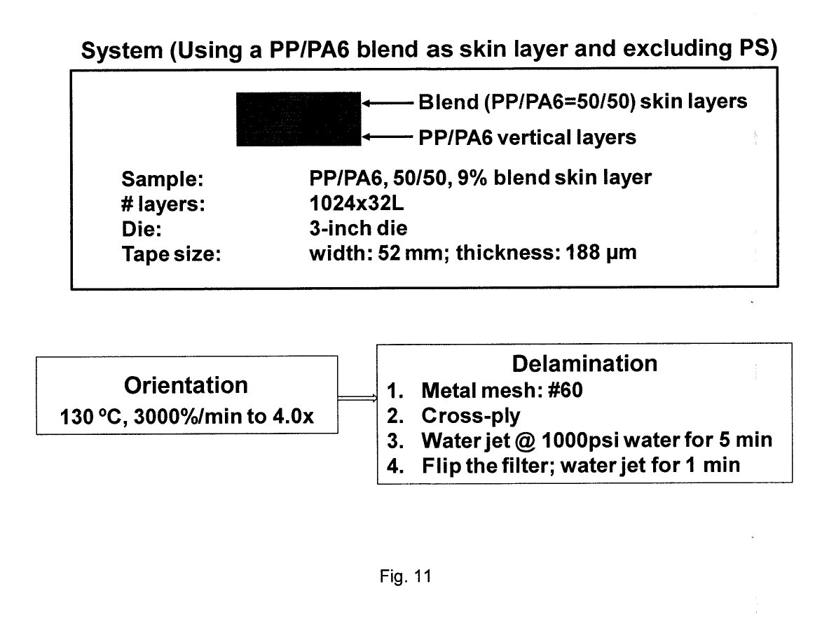

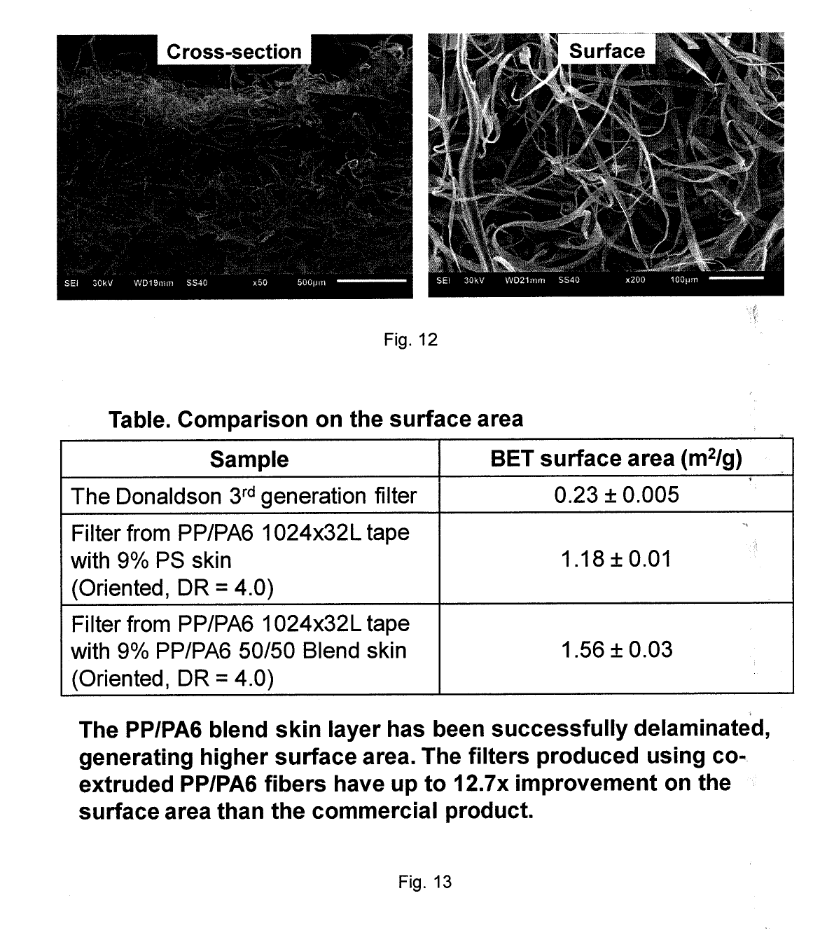

The coextruded multilayer tapes were oriented prior to delamination. The tapes were oriented at 130° C. at a rate of 3000%/min to 4.0x their length. The oriented coextruded multilayer tape were then delaminated using a delamination process described above. In the delamination process, a set of four fiber tapes (width=12 mm, thickness=0.25 mm) placed parallel to one another on a metal plate. A #60 metal mesh was placed over the tapes to secure the tapes to the mesh. A 1000 psi water jet was applied to the top side of the tapes. As shown in FIG. 12, delaminating was uniform throughout the thickness of the filter. By using the metal mesh, the PP and PA6 fibers were distributed uniformly and the thickness of the fibers was largely decreased. The rectangular nanofibers of the filter had a width of about 1 μm to about 25 μm (e.g., about 12.9 μm) and a thickness of about 0.5 μm to about 2.5 μm (e.g., about 1.5 μm).

FIGS. 12 illustrates SEM images of nanofibers of an oriented fuel filter produced from extruded PP/PA6 polymer fibrous substrates containing PP/PA6 as an encapsulation or skin layer. Both the surface and the cross-sectional sample were prepared for each filter. The cross-sectional samples were made by cutting the filter using a razor blade. The samples were coated with gold, and were observed using a JEOL SEM instrument at various magnifications.

The Brunauer-Emmett-Teller (BET) Theory surface area of filters made from oriented PP/PA6 fibers with a 9% PP/PA6 50/50 blend skin were compared to filters made from oriented PP/PA6 fibers with a 9% PS skin and commercially available fuel filters.

For the surface area data, the filter samples were dried and degassed at 70° C. for two hours under a nitrogen gas atmosphere. The surface area for each filter was measured using a Micromeritics Tristar II BET instrument.

FIG. 13 shows that filters made from made from oriented PP/PA6 fibers with a 9% PP/PA6 50/50 blend skin and oriented PP/PA6 fibers with a 9% PS skin have a higher surface area than the commercially available fuel filters.

### Example 4

A fiber-based water filter was made by coextruding and multiplying 50/50 PP/PVDF blends with PS separation layers. Within the blends, the PP provided low cost and high mechanical properties while the PVDF provided anti-fouling and chemical stability to the blend. In one instance, the PP/PVDF blend was coextruded with a 10% PS separation layer to form a 512×64 layer multilayered polymer composite films that exited the extrusion dies as 3.3 mm wide tapes. The tapes were axially oriented at 150° C. at a rate of 100%/min, a draw ratio of 6.0, and a gauge length of 30 mm. The oriented tapes were compressed at 1400 psi for 10 minutes at 120° C. The three components were delaminated from one another using a water jet having a pressure of about 500-750 psi for 40 minutes at about room temperature, thereby forming a plurality of rectangular PP fibers and a plurality of rectangular PVDF fibers. The PS material was discarded. The rectangular PP and PVDF fibers were compression molded at 1400 psi for 2 minutes at 40° C. The resulting oriented, rectangular PP and PVDF fibers had a nominal size of 0.25×1.18 μm and produced a PP/PVDF filter having a surface area of 1.17 m²/g. For comparison, electrospun PVDF filters have a surface area on the order of 2.58 m²/g and phase inversion PVDF filters have a surface area on the order of 16.21 m²/g.

In another instance, the PP/PVDF blend was coextruded with a 9% PS separation layer to form a 512×64 layer multilayered polymer composite films that exited the extrusion dies as 13 mm wide tapes. The tapes were axially oriented at 150° C. at a rate of 100%/min, a draw ratio of 4.0, and a gauge length of 30 mm. The oriented tapes were compressed at 1500 psi for 10 minutes at 80° C. The three components were delaminated from one another using a water jet having a pressure of about 500 psi for 40 minutes at about room temperature, thereby forming a plurality of rectangular PP fibers and a plurality of rectangular PVDF fibers. The PS material was discarded. The rectangular PP and PVDF fibers were compression molded at 1500 psi for 10 minutes at 80° C. The resulting oriented, rectangular PP and PVDF fibers formed a membrane having stronger bonding in the transverse direction.

It is expected that the PP/PVDF fibers have a diameter of about 0.1-1 μm and form a water filter having a thickness of about 100-200 μm, with a substantially uniform pore size of 0.1-10 μm and a porosity larger than 70%.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

Having described the invention, the following is claimed:

1. A filter comprising:
a fibrous substrate that includes a plurality of coextruded first polymer material fibers and second polymer material fibers, each of the first and second fibers being separated from each other and having a rectangular cross-section defined in part by an additional encapsulating polymer material that is separated from the first polymer material fibers and second polymer material fibers.

2. The filter of claim 1, wherein the first polymer material comprises polypropylene, the second polymer material comprises polyethylene, and the encapsulating polymer material comprises polystyrene.

3. The filter of claim 1, wherein the first polymer material comprises polypropylene, the second polymer material comprises a polyamide, and the encapsulating polymer material comprises polystyrene.

4. The filter of claim 1, wherein the first polymer material comprises polypropylene, the second polymer material comprises a polyamide, and the encapsulating polymer material comprises a blend of polypropylene and the polyamide.

5. The filter of claim 1, wherein, the first polymer material comprises polypropylene, the second polymer material comprises polyvinylidene fluoride, and the encapsulating polymer material comprises polystyrene.

6. The filter of claim 1, wherein the filter is an air filter.

7. The filter of claim 6, wherein the first polymer material comprises polypropylene, the second polymer material comprises polyethylene, and the additional encapsulating polymer material comprises a blend of polypropylene and polyethylene.

8. The filter of claim 6, wherein the polymer materials are surface charged to improve dust collection efficiency.

9. The filter of claim 1, wherein the filter is a fuel filter and the polymer materials have an intermediate hydrophilicity and water-coalescing capability.

10. The fuel filter of claim 9, wherein the first polymer material comprises polypropylene, the second polymer material comprises polyamide 6, and the encapsulating polymer material comprises polystyrene.

11. The fuel filter of claim 9, wherein the first polymer material comprises a blend of polypropylene and polyamide 6, the second polymer material comprises a blend of polypropylene and polyamide 6 different than the blend of the first polymer material, and the encapsulating polymer material comprises polystyrene.

12. The fuel filter of claim 9, wherein the first polymer material comprises polypropylene, the second polymer material comprises polyamide 6, and the encapsulating polymer material comprises a blend of polypropylene and polyamide 6.

13. The filter of claim 1, wherein the filter is a water filter and the polymer materials have an intermediate hydrophilicity and water-coalescing capability, wherein the fibers have a greater surface-area-to-volume ratio than electrospun fibers with the same cross-sectional area.

14. The filter of claim 13, wherein the first polymer material comprises polypropylene, the second polymer material comprises polyvinylidene fluoride, and the encapsulating polymer material comprises polystyrene.

15. The filter of claim 13, wherein the first polymer material comprises polypropylene, the second polymer material comprises polyvinylidene fluoride, and the encapsulating polymer material comprises a blend of polypropylene and polyvinylidene fluoride.

16. The filter of claim 13, wherein the first polymer material comprises polyethylene, the second polymer material comprises polyvinylidene fluoride, and the encapsulating polymer material comprises polystyrene.

17. The filter of claim 13, wherein the first polymer material comprises polyethylene, the second polymer material comprises polyvinylidene fluoride, and the encapsulating polymer material comprises a blend of polyethylene and polyvinylidene fluoride.

18. The filter of claim 13, wherein the first polymer material comprises cellulose acetate, the second polymer material comprises polyamide 6, and the encapsulating polymer material comprises polystyrene.

19. The filter of claim 13, wherein the first polymer material comprises cellulose acetate, the second polymer material comprises polyamide 6, and the encapsulating polymer material comprises a blend of cellulose acetate and polyamide 6.

20. A fuel filter comprising:
a fibrous substrate that includes a plurality of coextruded first polymer material fibers and second polymer material fibers, each of the first and second fibers being separated from each other and having a rectangular cross-section defined in part by an additional encapsulating polymer material that is separated from the first polymer material fibers and second polymer material fibers, the first and second polymer materials having an intermediate hydrophilicity and water-coalescing capability.

21. The fuel filter of claim 20, wherein the first polymer material comprises polypropylene, the second polymer material comprises polyamide 6, and the additional encapsulating polymer material comprises polystyrene.

22. The fuel filter of claim 20, wherein the first polymer material comprises a blend of polypropylene and polyamide 6, the second polymer material comprises a blend of polypropylene and polyamide 6 different than the blend of the first polymer material, and the additional encapsulating polymer material comprises polystyrene.

23. The fuel filter of claim 20, wherein the first polymer material comprises polypropylene, the second polymer material comprises polyamide 6, and the additional encapsulating polymer material comprises a blend of polypropylene and polyamide 6.

24. A method for producing a fibrous substrate comprising:
coextruding at least two polymer material to form a multilayered polymer composite stream that includes a plurality of polymer fibers formed from each polymer material, each polymer fiber having a rectangular cross-section;
coextruding the multilayered composite stream with an additional encapsulating polymer material to form a multilayered polymer composite film; and
separating the polymer materials to form a fibrous substrate comprising the plurality of the polymer material fibers having the rectangular cross-section.

25. The method of claim 24, wherein separating the polymer materials to form the fibrous substrate comprises applying a high pressure water stream to the multilayered composite film.

26. The method of claim 24, wherein separating the polymer materials to form the fibrous substrate comprises applying a high pressure air stream to the multilayered composite film.

27. The method of claim 24, wherein separating the polymer materials to form the fibrous substrate comprises applying a solvent to the multilayered composite film to dissolve the encapsulating polymer material.
